(19) United States
(12) Patent Application Publication
(10) Pub. No.: US 2016/0026966 A1
(43) Pub. Date: Jan. 28, 2016

(54) SYSTEM AND METHOD FOR MONITORING EVENT SCHEDULES

(71) Applicant: Yosef Akselrud, Brooklyn, NY (US)

(72) Inventor: Yosef Akselrud, Brooklyn, NY (US)

(21) Appl. No.: 14/444,031

(22) Filed: Jul. 28, 2014

(51) Int. Cl. G06Q 10/06

(52) U.S. Cl. CPC G06Q 10/063116

(57) ABSTRACT

A system and method for monitoring and maintaining compliance events includes, providing a database with a non-transitory computer readable storage medium for receiving, outputting, selectively sorting compliance event information, inputting compliance event into said database, said compliance event including at least one compliance date and at least one threshold date for compliance reminder, outputting at least one reminder once said threshold date is reached, inputting information relating to completed compliance of said compliance event; and optionally, configuring a subsequent compliance date for future notification.

### BACKGROUND OF THE INVENTION

While there are significant advances in electronic calendars and event reminders, there still is a deficiency relating to compliance type reminders. Current systems are deficient in failing to monitor and generate compliance with particularized events.

The present invention addresses these deficiencies.

### SUMMARY OF THE INVENTION

In one embodiment, the present invention is a method for monitoring and maintaining compliance events, said method comprising the steps of:

providing a database with a non-transitory computer readable storage medium for receiving, outputting, selectively sorting compliance event information;

inputting compliance event into said database, said compliance event including at least one compliance date and at least one threshold date for compliance reminder;

outputting at least one reminder once said threshold date is reached;

inputting information relating to completed compliance of said compliance event; and

optionally, configuring a subsequent compliance date for future notification.

In one embodiment, the database is operatively associated with a device configured for electronic communication of said reminder by e-mail, text message, phone call, fax, electronic calendar reminder, or combinations thereof. The type of electronic communication is selected by a person or organization receiving said communication and can be sent by identical forms of communication or different forms of communication. For example, an agency can get an e-mail and an individual gets a phone call. The inputting compliance event includes a query of the database for correlation with known compliance schedules. As one non-limiting example, the event is for bi-annual administration of a pharmaceutical product, the database is configured with the dosing regimen, recognizes, the known regimen, and automatically schedules future events.

The outputting of at least one reminder includes subsequent reminders generated until the system is provided input that compliance is completed or event is terminated.

Also contemplated is a computer system for monitoring scheduled event compliance, said system comprising:

a computer having a database according to the present invention; and

an electronic communication configuration operatively associated with said computer, said electronic communication being selectively configurable by an intended recipient of said communication.

### BRIEF DESCRIPTION OF THE SEVERAL VIEWS OF THE DRAWINGS

FIG. 1 is a flowchart demonstrating the first portion of the system and method according to one embodiment of the present invention.

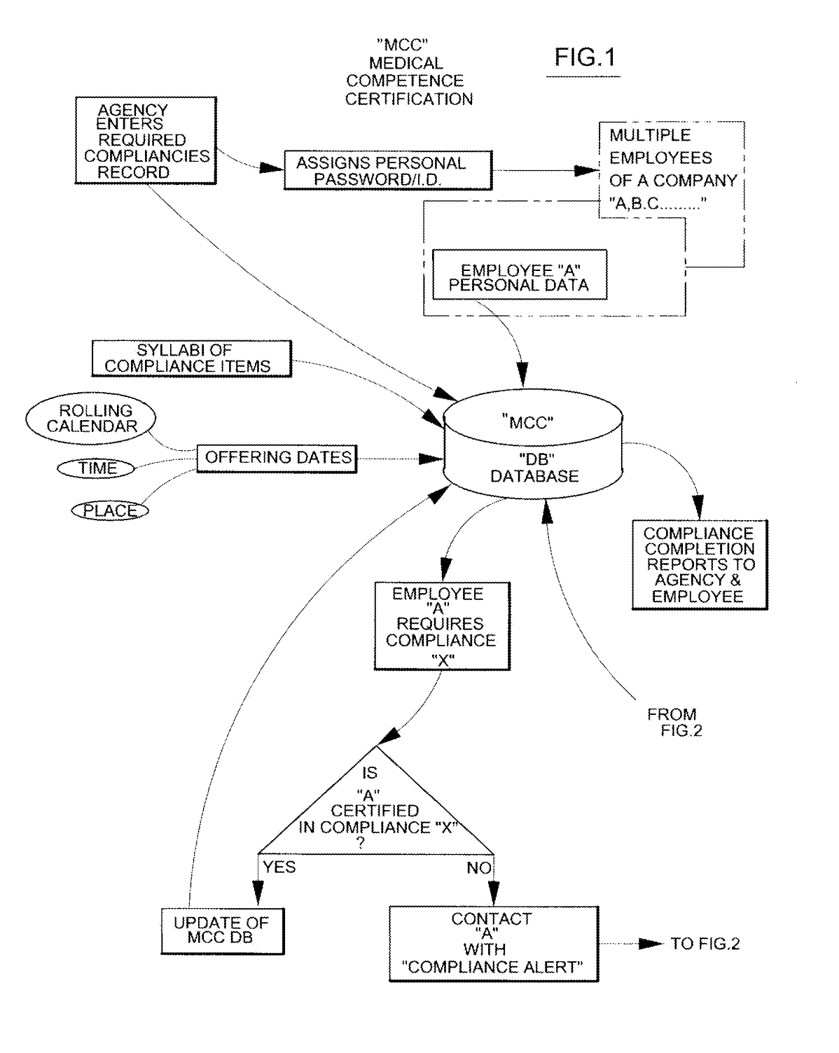

FIG. 2 is a flowchart demonstrating the second portion of the system and method according to one embodiment of the present invention.

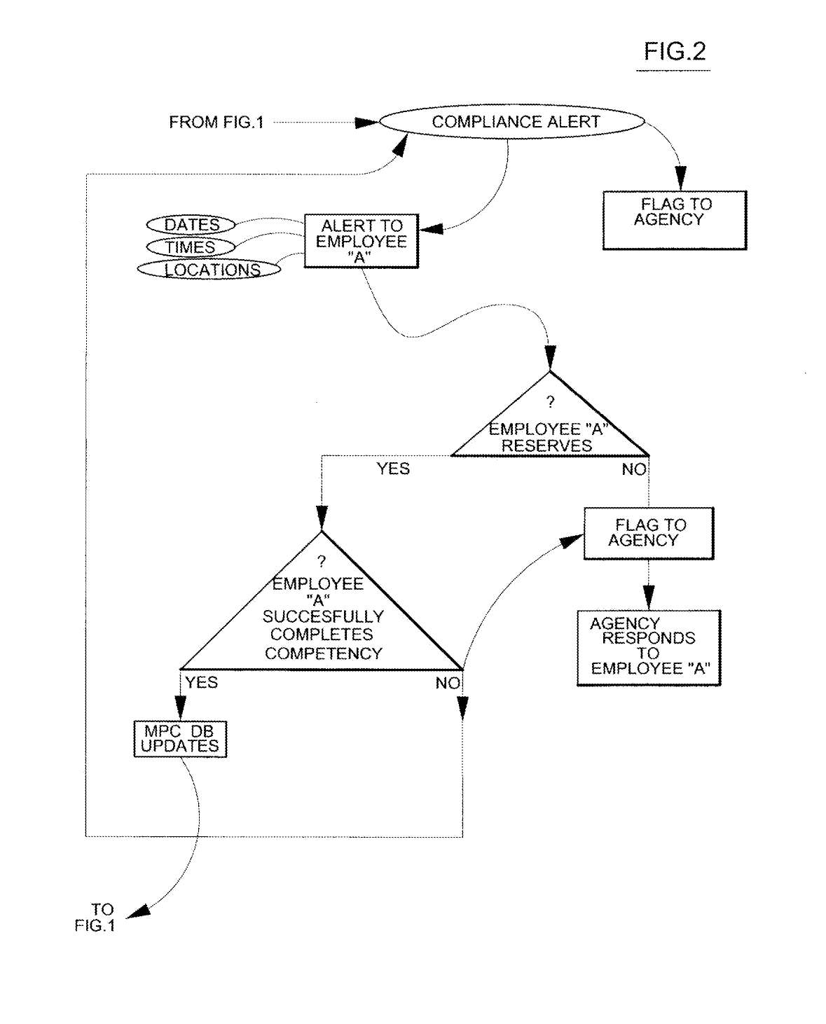

### DETAILED DESCRIPTION OF THE PREFERRED EMBODIMENT

The present invention is a system and method for ensuring ongoing and future compliance with expiring events. Although the embodiments and figures demonstrate compliance in a medical setting, it is contemplated the present invention be applicable to any situation in which an expiration date is present and requires an affirmative action in order to continue a particular course of action.

The system and method of the present invention includes a central database operatively associated with database storage on a non-transitory computer readable medium. An operator, such as an agency employee will enter a compliance record into the database of the present invention. As is known and understood, the employee is required to provide electronic identifying information such as a password or other information relating to computer system security, additionally, in one embodiment the present invention, particular records or batches of records are required to have a security identifier in order to access and or change the records. The database of the present invention compiles a syllabus of compliance items which are selectively sortable and output based on time, place, rolling calendar, offering dates, date range, combinations thereof, and the like. Upon request to an agency or employee, the database presents an output relating to compliance events. In one embodiment, the output is for compliance events occurring in the future. In another embodiment, the output relates to completed compliance events.

The database requires a particular compliance and is selectively configurable to electronically transmit notification. The notification can go to any one of the agency, an employee, in particular individual associated with the agency, and the like. In a case relating to medical compliance, it is contemplated that a physician's office receives compliance information. Additionally, it is contemplated that a patient directly receive compliance information relating to a particular event. The system and method is further configured to initiate a query as to the completion of the compliance event. For example, a patient is required to have a particular medical treatment every six months. The compliance event reminder is generated an output as configured by the system. The output is sent for weeks before the expiration date of the event. One week later, the patient arrives and completes the currently do treatment regimen. One week subsequent to treatment, the system again initiates a query as to compliance with treatment. However, this time the patient is in compliance and the database is updated as to current compliance and future compliance date requirement. Before and/or after the compliance date, the system is configured to send continual compliance reminders until receiving input relating to completion of a compliance event.

If, for some reason incorrect compliance information is entered, the system and method of the present invention is selectively configurable to alert by output any information relating to compliance error. For example, a particular treatment regimen is typically dosed once every six months for four years. However, a particular physician is placing the patient on a regimen for dosing every four months. Initial input is placed into the database and the database is configured to recognize certain compliance regimen such as prescription dosing. After the initial dosing, at the four-month period, the system is input with the administration of the form of dose. The system sends alert relating to an out of sequence event. However, the system is selectively configurable such that deviations from known compliance regimen are input and accommodated.

The compliance alert output by the system of the present invention is configured to be sent to an agency, a particular employee, a patient, combinations thereof, and the like. The compliance alert relates to any particular deadlines future or past and is configured to send continual alerts until the system is instructed to cease sending alerts. The cessation of sending alerts is based upon input and relates to either completion or termination of a particular compliance regimen.

In one embodiment, when an individual's compliance item is expiring (i.e. yearly refresher/recertification course, etc.) the system will automatically pull from the schedule of classes being loaded into the system the training centers available dates, times, and language preferences and will call/ text the individual based on their proximity to that training center location, language, class that is needed and will allow the individual to schedule by responses.

The following examples are illustrative only and not intended to limit the present invention.

### EXAMPLE A

1—If Jane Doe needs a flu shot and lives in zip code 11218,

2—the system will call/text Jane, notifying her that she needs to come in for a flu shot,

3—And offer her to come to the location nearest and/or provide either a list of alternative locations and/or allow her to limit location based on address.

4—Jane then selects A, that she will be coming.

5—Jane selects B to notify agency that she is allergic to flu shot

6—Agencies that Jane works for will be notified via email/dashboard that Jane can't take flu shot and will be required to wear a mask.

### EXAMPLE B

1—If John Doe's yearly refresher class is due based on it being a yearly occurrence, the system will automatically see that John speaks English, and lives in 11219,

2—An employee will enter into my system classes that are being given at each location, for each criteria, with time/date.

3—the system will call John X amount of time before his compliance expires.

4—The system will notify John via call/text that he needs to come in, and classes available to him are dates Mar. 4, 2014 @ 12 PM, Mar. 7, 2014 @ 9 AM, and Mar. 14, 2014 @ 9 am.

5—John will have the option to reserve a spot at the class that works best for him via the IVR or responding to the text message.

6—Once John selects the class his spot is reserved.

7—The agency/agencies that John works for will be notified via email and dashboard notification that John is scheduled for class at time and date.

7—He will receive a call/text X amount of time before the class, as well as the agency.

In one embodiment, when used in applications such as healthcare, the system is configured to identify a nurse/healthcare worker is noncompliant and it can automatically schedule another worker to take the noncompliant worker's place. The noncompliant worker will then be told not to work until the worker is in compliance. There are situations where a healthcare worker may not be allowed under law to work if they are noncompliant.

Additionally, the system is configurable to notify a regulatory agency or licensing authority to alert status of noncompliance. In one embodiment, where the system is configurable to notify a regulatory body of noncompliance, the system is understood to also notify of individuals and entities that are in compliance.

In one embodiment, the system is configurable to provide the agency will be alerted that the healthcare worker is not in compliance and the agency will also be presented with a list of available workers to take the place of the noncompliant worker. The list of workers is presented to the agency based a database of workers with schedules, availability, geographic location etc.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for monitoring and maintaining compliance events, said method comprising the steps of:
providing a database with a non-transitory computer readable storage medium for receiving, outputting, selectively sorting compliance event information;
inputting compliance event into said database, said compliance event including at least one compliance date and at least one threshold date for compliance reminder;
outputting at least one reminder once said threshold date is reached;
inputting information relating to completed compliance of said compliance event; and
optionally, configuring a subsequent compliance date for future notification.

2. The method of claim 1 wherein said database is operatively associated with a device configured for electronic communication of said reminder.

3. The method of claim 2 wherein said device configured for electronic communication of said reminder is an e-mail, text message, phone call, fax, electronic calendar reminder, or combinations thereof.

4. The method of claim 3 wherein said electronic communication is selected by a person or organization receiving said communication.

5. The method of claim 4 wherein more than two electronic communications are sent by identical forms of communication.

6. The method of claim 4 wherein more than two electronic communications are sent by different forms of communication.

7. The method of claim 1 wherein the inputting compliance event includes a query of the database for correlation with known compliance schedules.

8. The method of claim 1 wherein the outputting at least one reminder includes subsequent reminders generated until the system is provided input that compliance is completed or event is terminated.

9. The method of claim 1 wherein a non-compliant individual or entity is removed from a work schedule and replaced with a compliant individual or entity.

10. The method of claim 1 wherein a non-compliant individual or entity is removed from a work schedule and an output is provided including at least one available compliant individual based on at least one of said compliant individual's schedule, availability, geographic location or combinations thereof.

11. A system for monitoring scheduled event compliance, said system comprising:
a computer having a database according to claim 1;
an electronic communication configuration operatively associated with said computer, said electronic communication being selectively configurable by an intended recipient of said communication.
